(19) United States
(12) Patent Application Publication
(10) Pub. No.: US 2005/0065660 A1
(43) Pub. Date: Mar. 24, 2005

(54) Method for repairing an oil or gas pipeline

(76) Inventors: Jostein Aleksandersen, Randaberg (NO); Harald Syse, Royneberg (NO)

Correspondence Address: CHRISTIAN D. ABEL, ONSAGERS AS, POSTBOKS 6963 ST. OLAVS PLASS, NORWAY, N-0130, NO

(21) Appl. No.: 10/934,502

(22) Filed: Sep. 7, 2004

Related U.S. Application Data
(60) Provisional application No. 60/502,946, filed on Sep. 16, 2003.

(51) Int. Cl. F16L 55/12; G05B 21/00; G06F 19/00

(52) U.S. Cl. 700/266; 700/272; 700/110

(57) ABSTRACT

A method for repairing an oil or gas pipeline without disclosing sensitive technical information to the customer, comprising the steps of providing pre-certified plugs of standard sizes that are pre-manufactured and stored in a storage facility. When a request for a repair operation is received, a plan for executing a repair is formulated and executed by representatives of the plug manufacturer using the pre-manufactured plugs. In order to satisfy the customer's concerns for safety and effectiveness, the technical details of the plan, as well as the actual devices to be utilized in the repair, are examined and certified by an independent Quality Assurance body. However, neither the technical details of the repair plan, nor the technical specifications of the plugs themselves, are transmitted to the customer.

This application claims the benefit of U.S. Provisional Patent Application 60/502,946 filed 16 Sep. 2003.

### BACKGROUND

1. Field of the Invention

This invention relates to plugging systems used to isolate a section of an oil or gas pipeline, more specifically to a method of performing a plugging operation.

2. Description of the Prior Art

Petroleum products are commonly transported through pipelines. Particularly in the case of pipelines associated with production facilities and drilling operations the petroleum products are transported under high pressure. It is also a common occurrence that sections of the pipeline must occasionally be repaired. It is well known in the art that the repair and maintenance of oil pipelines is difficult and costly. In the worst case, a production facility must shut down temporarily in order for the repairs to be performed. This obviously can result in very large amounts of lost revenues for the operator.

In order to mitigate the losses associated with such repairs, various techniques have been developed to allow the repairs to be performed without the need for de-pressurising the pipelines. The simplest of such methods is to construct the pipeline with valves pre-positioned at predetermined locations along the pipeline. It is also well known in the art that this is an unsatisfactory solution, since it is difficult to predict the optimal location of the valves. In addition the valves that are unused for many years may become inoperable, particularly in the case of off shore pipelines.

The most recent technique for performing such repair operations involves the use of remotely controlled, autonomous, tetherless plugs that may be pigged into place and activated in order to isolate the area of repair, such as the plug described in patent applications PCT/NO02/00418, NO20023100, NO20023099, and NO20020559, the contents of which are hereby incorporated by reference.

Plugging as a general concept is not new, however there are many disadvantages to the manner in which such plugging operations have been implemented in the past. Previously, a plug manufacturer would design and construct a plug specifically for the repair job to be performed, which plug would be purchased and thereafter owned by the operator of the petroleum facility. This poses several disadvantages however for both the manufacturer and the operator.

As can be appreciated, such plugs are technically complex and very expensive devices that take a long time to manufacture. Often repairs must be performed quickly, and there is not enough lead time available to permit a plug to be designed and constructed. Even where there is sufficient lead time, the cost of the plug may outweigh the savings to be realized. Since the plugs will seldom be useful to the operator in the future, the purchase represents a one time investment that will not give any further returns. Plugging has therefore never before received the acceptance in the industry one would otherwise have expected.

From the perspective of the manufacture, there are also several problems associated with constructing and selling individual plugs for specific repair jobs. One of the prime disadvantages involves the potential disclosure of proprietary technical information concerning the design and construction of the plugs themselves.

As can be appreciated, the operators of petroleum facilities are extremely concerned about the safety and effectiveness of a plugging operation. As such, the operators have typically demanded to be intimately involved in the details of designing, manufacturing and testing the plugs that will be employed. This intimate involvement unfortunately allows the operator access to potentially sensitive, proprietary technical information during the construction phase. Once the sale of the device is complete, the plug will be further available to the operator and others for reverse engineering purposes.

### OBJECTS AND ADVANTAGES

The present invention has the object of providing a method of plugging an oil or gas pipeline without the need to disclose sensitive, proprietary technical information about the plugs to the petroleum operator. The invention has the further advantage of reducing the costs associated with plugging operations. The invention has yet the further advantage that a plugging operation can be performed with substantially reduced lead time.

### SUMMARY OF THE INVENTION

The present invention achieves the above-described objects and advantages by providing plugs of standard sizes that are pre-manufactured and stored in a storage facility. When a request for a repair operation is received, a plan for executing a repair is formulated and executed by representatives of the plug manufacturer using the pre-manufactured plugs. In order to satisfy the customer's concerns for safety and effectiveness, the technical details of the plan, as well as the actual devices to be utilized in the repair, are examined and certified by an independent Quality Assurance body. However, neither the technical details of the repair plan, nor the technical specifications of the plugs themselves, are transmitted to the customer.

### BRIEF DESCRIPTION OF THE DRAWINGS

The invention will be described in greater detail with reference to the following attachment and figures, wherein:

Attachment A is an example of a pipe stress calculation

FIG. 1 is a flow diagram of the method according to the invention

FIG. 2 is the first page of an example of a Product Certificate for a specific plug to be employed in a specific plugging operation

FIG. 3 is the second page of an example of a Product Certificate for a specific plug to be employed in a specific plugging operation

FIG. 4 is the first page of an example of a Type Approval Certificate for the standardized plugs utilized in the method

FIG. 5 is the second page of an example of a Type Approval Certificate for the standardized plugs utilized in the method

FIG. 6 is the third page of an example of a Type Approval Certificate for the standardized plugs utilized in the method

FIG. 7 is the fourth page of an example of a Type Approval Certificate for the standardized plugs utilized in the method

### DETAILED DESCRIPTION OF THE INVENTION

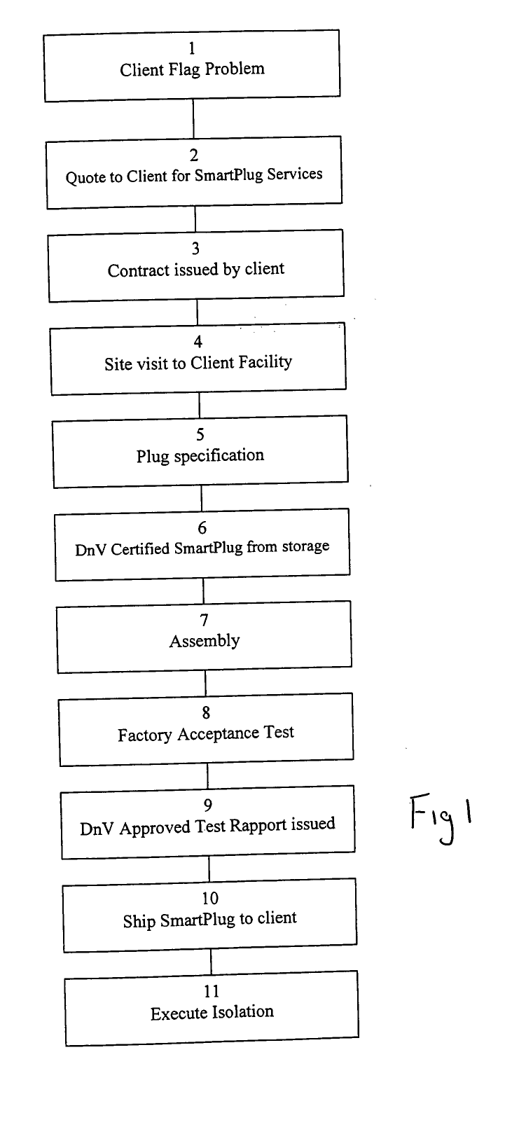

FIG. 1 graphically represents the steps involved in executing a plugging operation in an oil or gas pipeline that eliminates the need to transmit technical information about the operation to the operator of the facility.

Upon receiving a request for a repair operation, the customer is given a quote for plugging services. A contract or letter of intent is thereafter issued by the customer if it wishes to proceed.

Once approval is given by the customer, an on site inspection is made by a representative of the plugging service provider in order to assess the problem and define a plugging solution. The representative gathers all possible information on the pipeline system, potential problems are identified, and a site visit report is issued.

Based upon the site visit report, the plugging specification is defined. The customer's pipeline system is modelled on a computer device, and a stress test similar to that shown in attachment A is performed to verify that the subject pipeline has the necessary strength to permit the operation. A “piggability” study is performed of the subject pipeline to ensure that the plug device can negotiate the bends, turns etc. between the pig launcher and the repair location. In certain situations an actual full scale model of a potentially problematic section of the pipeline is constructed and a full scale pigging operation is simulated.

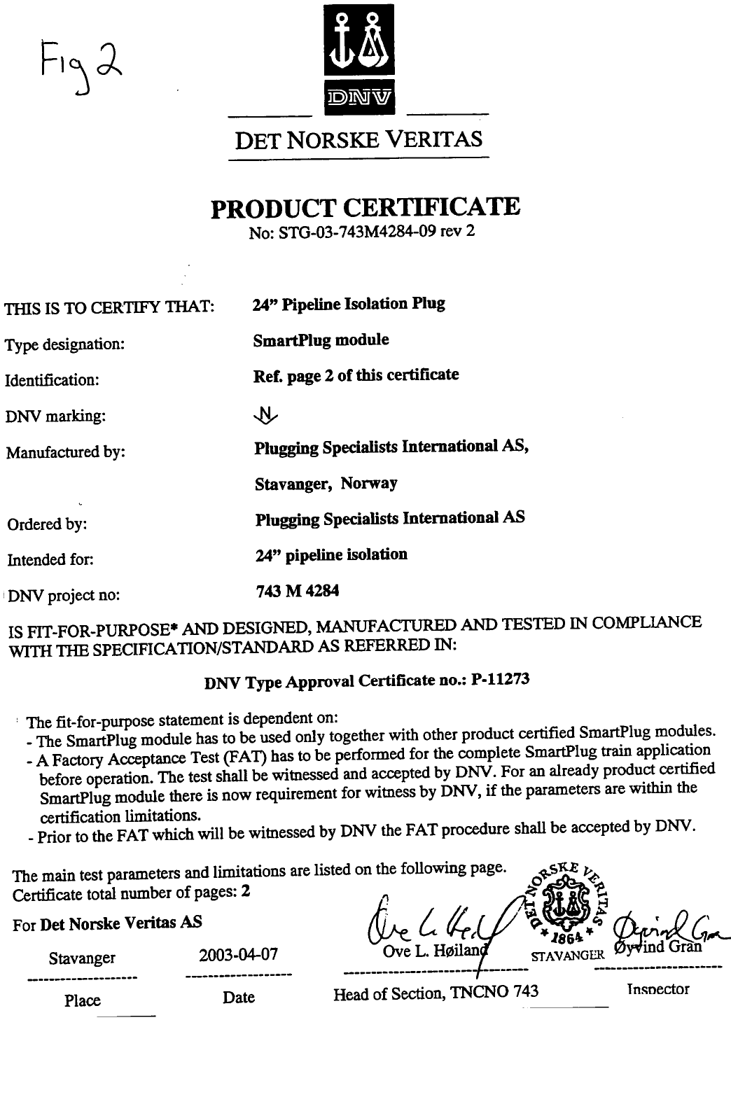

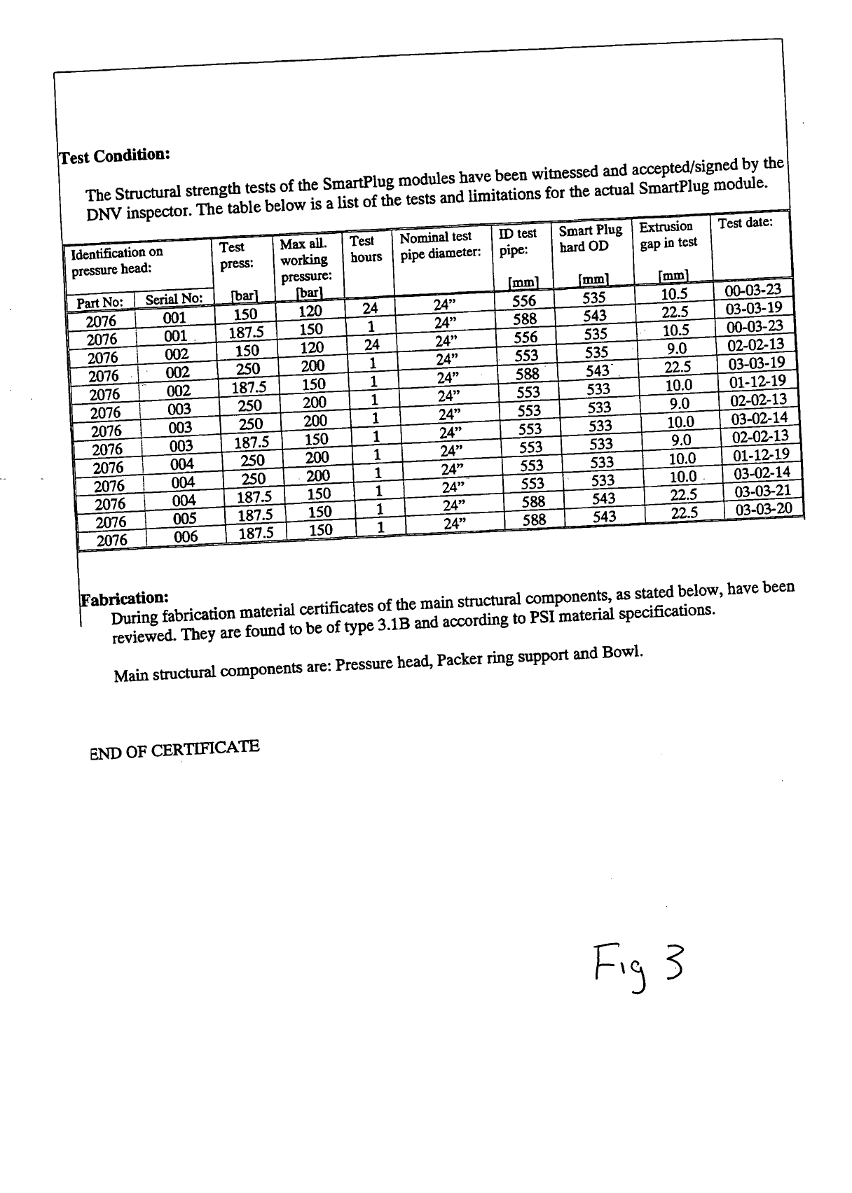

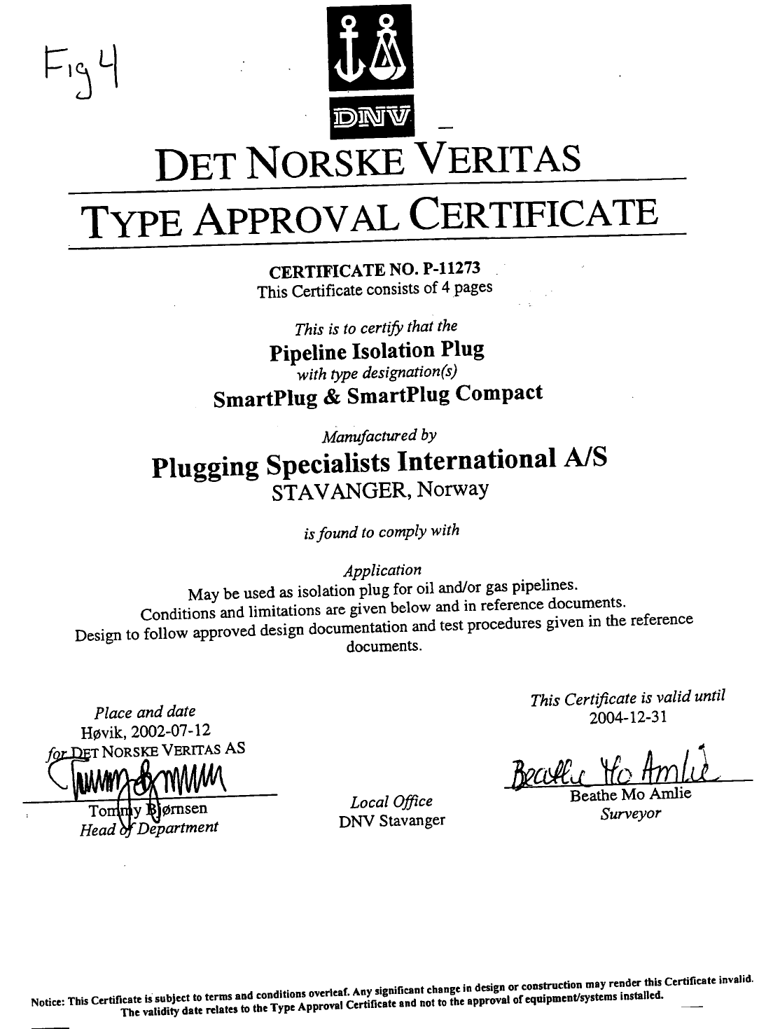

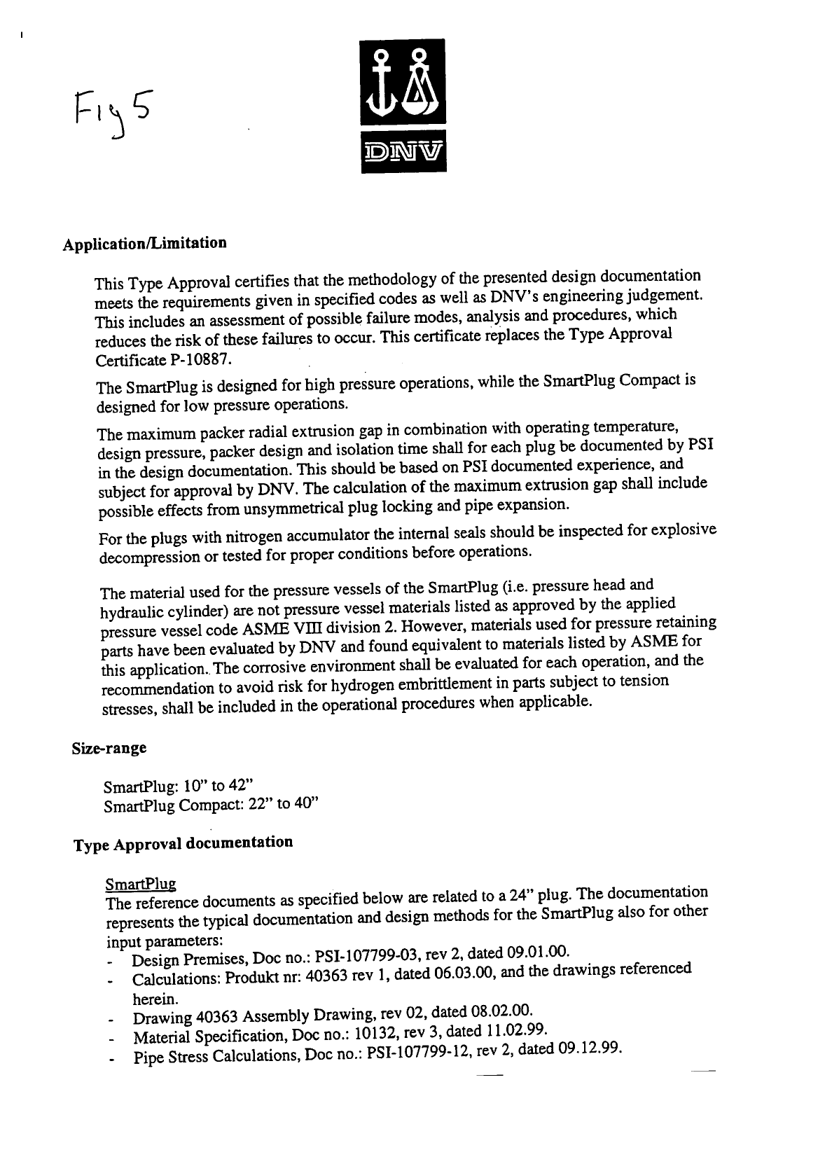

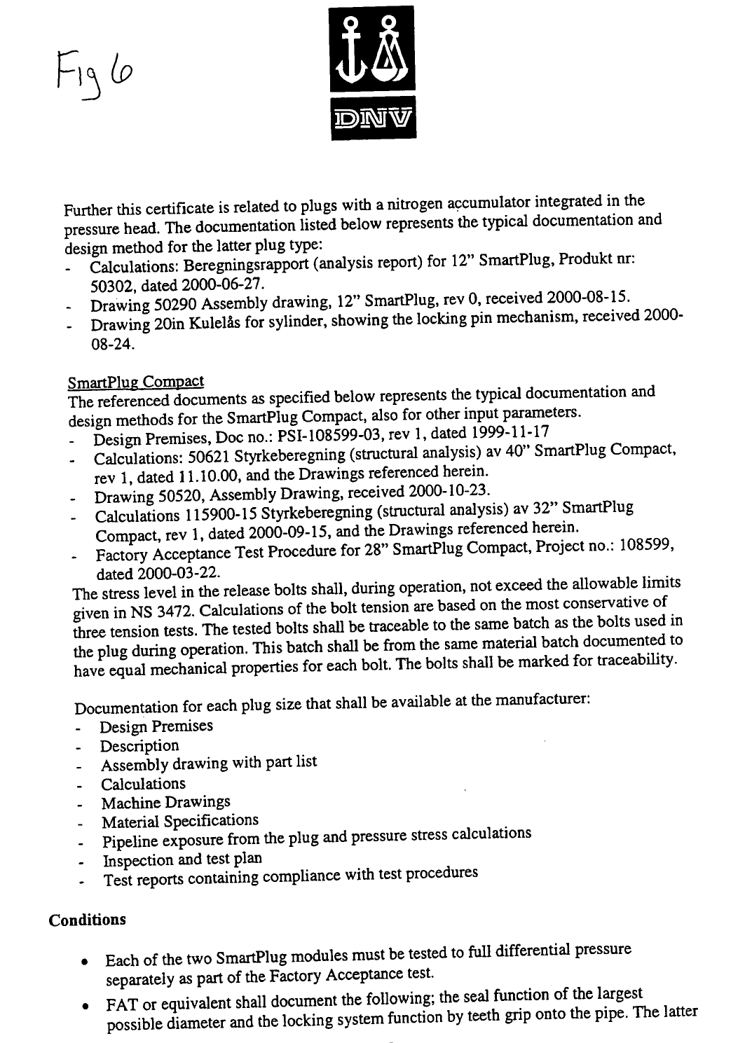

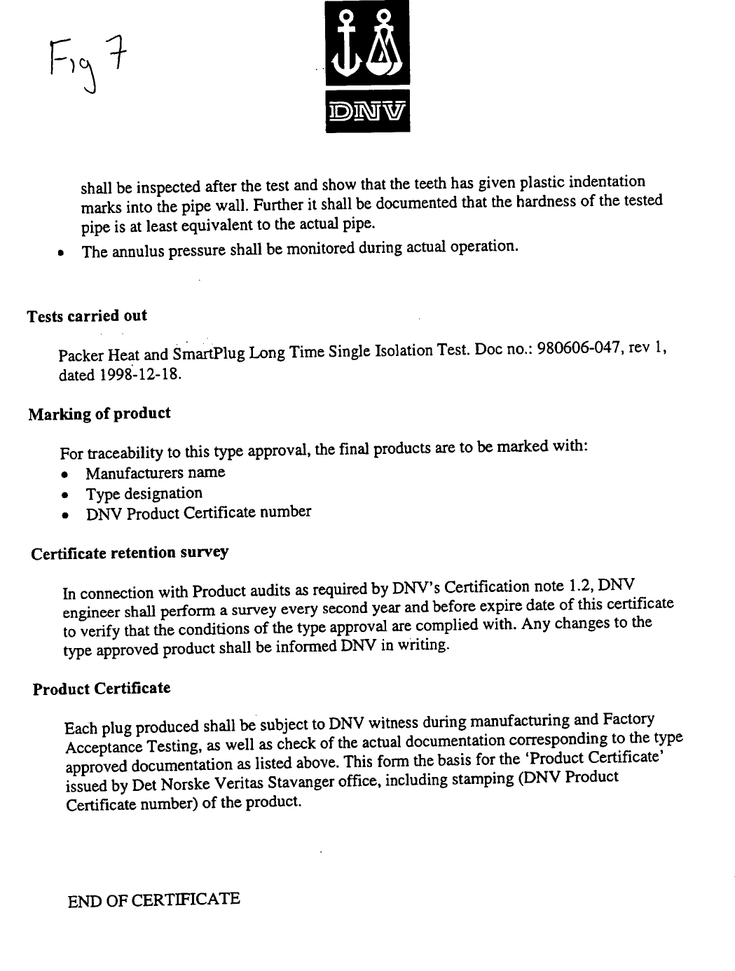

Once a repair plan is formulated, the appropriate plugs are selected from storage and assembled into the necessary arrangement. These plugs have previously been examined and certified by an Independent Quality Assurance body (FIGS. 2-3) which has also issued a “Type Approval” for the general specifications of the plug design. (FIGS. 4-7). During the assembly process, representatives of the Quality Assurance body witness the work, and issue a Factory Acceptance Certificate for the devices and the plan upon completion.

An important aspect of the invention is that the technical details of the plan, as well as the technical specifications of the actual plugs to be utilized, are transmitted to and approved by the independent Quality Assurance body under terms of strict confidentiality. The customer is specifically not permitted access to this information.

Once completed, the certified plugs are shipped to the repair site, where it is pigged into place and activated by representatives of the plug manufacturer. The necessary repairs can then be performed by the operator of the facility.

[image]

[image]

[image]

[image]

[image]

[image]

[image]

[image]

[image]

[image]

[image]

[image]

[image]

[image]

[image]

[image]

[image]

1. A method for repairing an oil or gas pipeline without disclosing sensitive technical information to the customer, comprising the steps of:
providing a stock of remotely controlled, autonomous, tetherless pipeline plugs of standard sizes,
pre-certifying the plugs by an independent quality assurance body, under terms of confidentiality regarding the technical details of the plugs,
receiving a repair request from a customer,
performing an onsite inspection,
formulating a repair plan,
pre-certifying the repair plan by an independent quality assurance body under terms of confidentiality regarding the technical details of the plan and the actual plugs to be utilized
shipping the plugs to the repair site,
pigging the plugs into place by representatives of the plug manufacturer,
activating the plugs, thereby sealing the pipeline, whereby the necessary repairs can thereafter be performed by the customer.

2. The method according to claim 1, whereby, following the onsite inspection, the customer's pipeline system is modelled on a computer and a stress test is performed to verify that the subject pipeline has the necessary strength to tolerate the plugging operation.

3. The method according to claim 2, further comprising the step of performing a piggability study to verify that the plugs can negotiate the bends, turns and the like between the pig launcher and the repair site.

4. The method according to claim 3, wherein the piggability study comprises the construction of a full-scale model of a potentially problematic area of the pipeline.

5. The method according to claim 3 or 4, whereby, following the formulation of the repair plan, representatives of the independent quality assurance body witness the assembly of the actual plugs to be utilized in the specific repair operation.
